(19) United States
(12) Patent Application Publication
(10) Pub. No.: US 2023/0392785 A1
(43) Pub. Date: Dec. 7, 2023

(54) WELDING OR CUTTING TORCH

(71) Applicant: IHT Automation GmbH & Co. KG, Baden-Baden (DE)

(72) Inventor: Kurt NACHBARGAUER, Baden-Baden (DE)

(73) Assignee: IHT Automation GmbH & Co. KG, Baden-Baden (DE)

(21) Appl. No.: 17/829,594

(22) Filed: Jun. 1, 2022

(51) Int. Cl. F23D 14/54; B23K 7/00; B23K 5/00

(52) U.S. Cl. CPC F23D 14/54; B23K 5/00; B23K 7/00

(57) ABSTRACT

A welding or cutting torch includes a torch head, a heating nozzle detachably fastened onto a front part of the torch head and a cutting nozzle, which is received in the heating nozzle and which rests with a rear end face on a front end face of the torch head. The cutting nozzle has a shoulder with a surrounding contact face, which is turned away from a rear end face and which rests on a surrounding mating face of the heating nozzle.

### BACKGROUND OF THE INVENTION

### 1. Field of the Invention

The invention relates to a welding or cutting torch as disclosed herein.

### 2. Description of the Related Art

Known welding or cutting torches of this type have a torch head to which lines for supplying fuel gas and oxygen are routed and at the front end of which a heating nozzle for treating workpieces by means of a flame and a cutting nozzle received in the heating nozzle for treating the workpieces with cutting oxygen are disposed. The heating nozzle together with the cutting nozzle received in it is fastened detachably on the torch head. This cutting nozzle is a wear-susceptible part, which is exposed during operation to high temperatures and/or aggressive chemical substances.

### SUMMARY OF THE INVENTION

It is therefore the task of the invention to further develop a welding or cutting torch of the type mentioned in the introduction to the point that the cutting nozzle can be replaced more easily.

This task is accomplished according to the invention by a welding or cutting torch having the features disclosed herein. Advantageous further developments of the invention are also disclosed.

The invention is based on the idea of exactly positioning the cutting nozzle in the heating nozzle by contact of the surrounding contact face turned away from the rear end face against the surrounding mating face on the heating nozzle. In particular, when the cutting nozzle is received loosely in the heating nozzle and its rear end face is held in contact against the front end face of the torch head by means of contact of the mating face against the contact face, only the heating nozzle has to be removed from the torch head for replacement of the cutting nozzle. This may often be achieved without the use of special tools.

Advantageously, the cutting nozzle has a further shoulder with a surrounding further contact face, which is turned away from the rear end face and rests on a further surrounding mating face of the heating nozzle. This feature permits even better positioning of the cutting nozzle in the heating nozzle. Expediently, the further shoulder is disposed closer to the rear end face than the shoulder, and the further contact face is smaller than the contact face. Furthermore, the further contact face is advantageously oriented obliquely relative to the rear end face, while the contact face is oriented parallel to the rear end face. Also, the contact of the further mating face against the further contact face contributes to a more reliable pressing of the rear end face of the cutting nozzle against the front end face of the torch head.

It is preferred that the heating nozzle be fastened onto the torch head by means of a bayonet coupling, wherein an end part of the heating nozzle surrounds a front part of the torch head provided with the front end face, and wherein pins extend radially inwardly from the end part and respectively engage in a curved guide in the extension. A bayonet coupling is a joint that can usually be separated even without tools. For this purpose, it is preferred that the bayonet coupling have at least three pins protruding radially from the end part of the heating nozzle as well as a corresponding number of guides. These are expediently disposed at equal angular spacings relative to one another. The use of at least three pins compared with a bayonet joint having only two pins situated opposite one another has the advantage that it is more stable and less susceptible to wear. In a bayonet coupling having two pins situated opposite one another, the problem exists that, due to wear or play present from the beginning, the pins form a pivot axis around which the heating nozzle may be swiveled to a limited extent, for example when it encounters an obstruction. Already existing play is then enlarged upon each collision. In contrast, if at least three pins are present, they cannot all lie in a common pivot axis, and so the above-mentioned problem cannot occur.

The cutting nozzle expediently has a base body, which consists in one piece of copper or of a copper alloy, which is provided with a coating at least on a cutting nozzle tip that has an outlet opening for the cutting jet. Copper is favorable, and from the viewpoint of heat conduction is advantageous. However, it is not sufficiently resistant, for example, to slag being spattered from a workpiece. It is for this reason that the coating is provided, which is preferably generated by means of physical vapor deposition, by means of chemical vapor deposition or by means of plasma-enhanced chemical vapor deposition and/or is an amorphous carbon layer, in particular diamond-like carbon (DLC). Usually it is sufficient to provide a part of the cutting nozzle turned toward the workpiece with the coating, wherein the coated part comprises in particular a cutting-nozzle tip projecting from the heating nozzle.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the Drawings,

FIG. 1 shows a welding or cutting torch in perspective view;

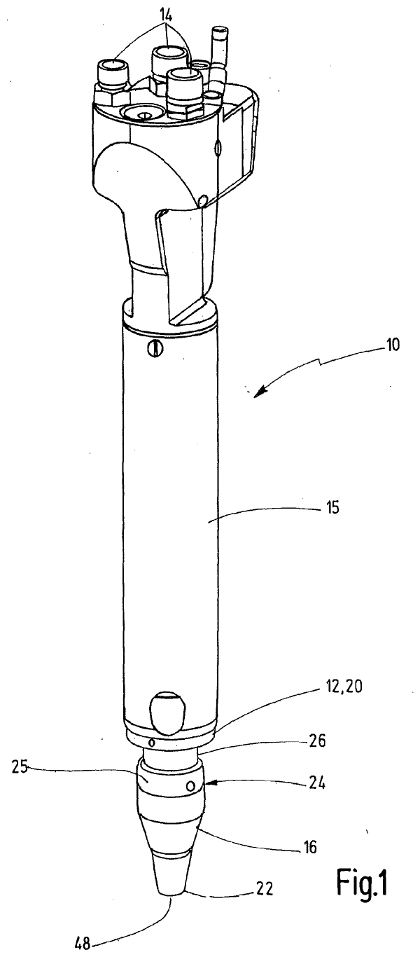

FIG. 2 shows a partial side view of the welding or cutting torch according to FIG. 1 in exploded representation, and

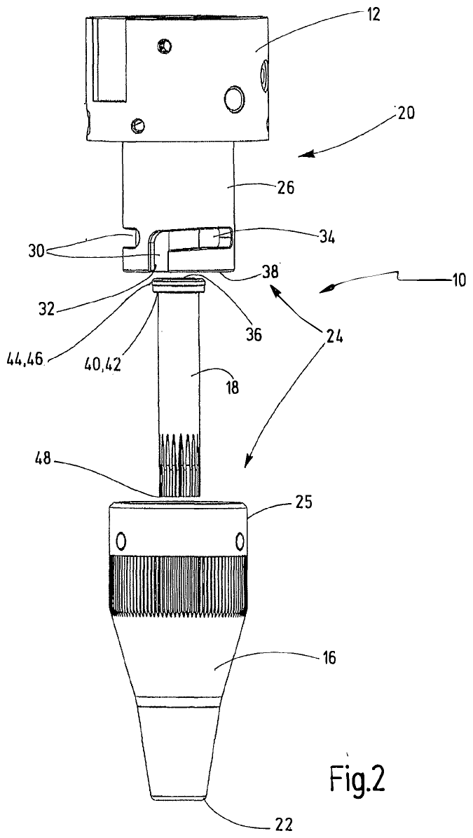

FIG. 3 shows a perspective partial view of the welding or cutting torch according to FIG. 1 in exploded representation.

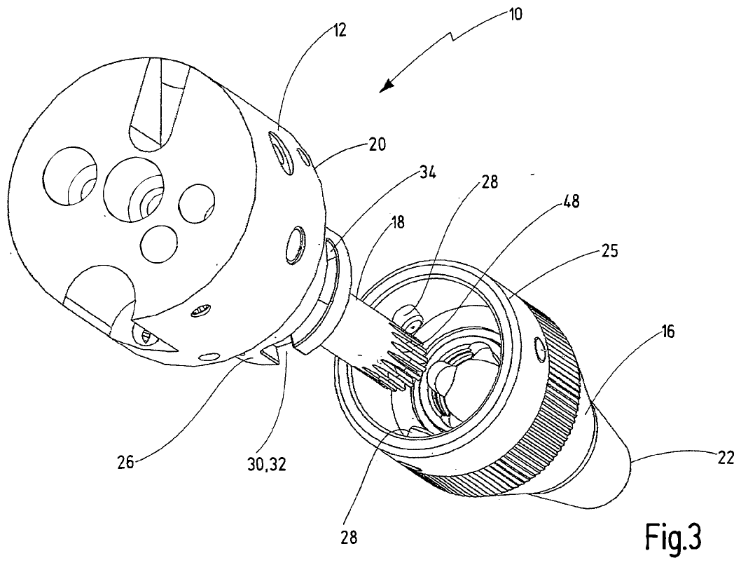

### DETAILED DESCRIPTION OF THE DRAWINGS

The welding or cutting torch 10 illustrated in the drawing has a torch head 12, to which supply lines for fuel gas, cutting oxygen, etc. extend from ports 14 and further through it to a heating nozzle 16 and a cutting nozzle 18, which are disposed on a front part 20 of the torch head 12. The torch head 12 is fastened onto an outer tube 15, through which the supply lines are routed. The heating nozzle 16, from the heating nozzle tip 22 of which, turned away from the torch head 12, a heating flame directed onto a workpiece emerges during operation, is in this case detachably fastened by means of a bayonet coupling 24 onto an extension 26 on the front part 20 of the torch head 12. The bayonet coupling 24 has three pins 28, which extend radially inwardly from an end part 25 of the heating nozzle 16 surrounding the extension 26 and which are disposed at equal angular spacings of 120° relative to one another. These angular spacings correspond to the angles between the central axes extending through the pins 28. The bayonet coupling 24 additionally has three guides in the form of guide gates 30 on the extension 26, which are likewise disposed at equal angular spacings relative to one another, and which respectively have a first portion 32 extending in axial direction and a second portion 34 adjoining the first portion 32 and extending in circumferential direction. The first portions 32 are open at the rim, so that respectively one of the pins 28 can be introduced into it.

The cutting nozzle 18 is loosely received in the heating nozzle 16 and rests with a rear end face 36 on a front end face 38 of the torch head 12 that terminates the extension 26. It has a shoulder 40 with a surrounding contact face 42, which is turned away from the rear end face 36 and is parallel to it. Between the shoulder 40 and the rear end face 36, a further shoulder 44 is situated with a surrounding further contact face 46, which is turned away from the rear end face 36 and which is inclined obliquely relative to the rear end face 36. In the interior of the heating nozzle 16, a mating face complementary to the contact face 42 is situated, as is a further mating face complementary to the further contact face 46, so that the cutting nozzle 18 is held in contact, with its rear end face 36 opposite the front end face 38 by contact of the mating face against the contact face 42 and by contact of the further mating face against the further contact face 46, when the heating nozzle 16 is fastened by means of the bayonet coupling 24 onto the torch head 12.

The cutting torch 18 has a base body of copper. This is provided, by means of physical vapor deposition, at least on a cutting-nozzle tip 48 projecting from the heating-nozzle tip 22, with a chemically resistant and temperature-resistant coating.

1. A welding or cutting torch comprising a torch head (12), a heating nozzle (16) detachably fastened onto a front part (20) of the torch head (12) and a cutting nozzle (18), which is received in the heating nozzle (16) and which rests with a rear end face (36) on a front end face (38) of the torch head (12), wherein the cutting nozzle (18) has a shoulder (40) with a surrounding contact face (42), which is turned away from a rear end face (36) and which rests on a surrounding mating face of the heating nozzle (16).

2. The welding or cutting torch according to claim 1, wherein the cutting nozzle (18) has a further shoulder (44) with a surrounding further contact face (46), which is turned away from the rear end face (36) and rests on a further surrounding mating face of the heating nozzle (16).

3. The welding or cutting torch according to claim 2, wherein the further shoulder (44) is disposed closer to the rear end face (36) than the shoulder (40), and in that the further contact face (46) is smaller than the contact face (42).

4. The welding or cutting torch according to claim 2, wherein the further contact face (46) is oriented obliquely relative to the rear end face (36).

5. The welding or cutting torch according to claim 1, wherein the contact face (42) is oriented parallel to the rear end face (36).

6. The welding or cutting torch according to claim 2, wherein the cutting nozzle (18) is received loosely in the heating nozzle (16) and in that the rear end face (36) is held in contact against the front end face (38) by means of contact of the mating face against the contact face (42) and if necessary by means of contact of the further mating face against the further contact face (46).

7. The welding or cutting torch according to claim 1, wherein the heating nozzle (16) is fastened onto the torch head (12) with a bayonet coupling (24), wherein an end part (25) of the heating nozzle (16) surrounds the front part (20), provided with the front end face (38), of the torch head (12), and wherein pins (28) extend radially inwardly from the end part (25) and respectively engage in a curved guide (30) in the extension (26).

8. The welding or cutting torch according to claim 7, wherein the bayonet coupling (24) has at least three pins (28) protruding radially from the end part (25) of the heating nozzle (16).

9. The welding or cutting torch according to claim 8, wherein the at least three pins (28) are disposed at equal angular spacings relative to one another.

10. The welding or cutting torch according to claim 1, wherein the cutting nozzle (18) has a base body, which consists of one piece of copper or a copper alloy and which is provided with a coating at least on a cutting nozzle tip (48) that has an outlet opening for a cutting jet.

11. The welding or cutting torch according to claim 10, wherein the coating is generated by physical vapor deposition, by chemical vapor deposition or by plasma-enhanced chemical vapor deposition and/or is an amorphous carbon layer, in particular diamond-like carbon (DLC).
